(19) United States
(12) Patent Application Publication
(10) Pub. No.: US 2022/0040551 A1
(43) Pub. Date: Feb. 10, 2022

(54) SYNCHRONOUS CONTROL METHOD FOR BOXING PUNCHING BAG

(71) Applicant: Tien-Yu Chen, New Taipei (TW)

(72) Inventors: Tien-Yu Chen, New Taipei (TW); Yun-Chien Chen, Taipei (TW)

(21) Appl. No.: 17/389,707

(22) Filed: Jul. 30, 2021

(30) Foreign Application Priority Data
Aug. 5, 2020 (TW) 109126459

(51) Int. Cl. A63B 69/32; H04L 29/08; H04W 56/00; G08B 5/36; A63B 69/20; A63B 71/06; A63B 24/00

(52) U.S. Cl. CPC A63B 69/32; H04L 67/12; H04W 56/001; H04W 84/12; A63B 69/201; A63B 71/0622; A63B 24/0062; G08B 5/36

(57) ABSTRACT

A synchronous control method for boxing punching bag is provided. The method includes the following steps: disposing a coach punching bag; sensing a boxing movement from a coach by the plurality of IoT sensors and converting punching positions of the boxing movement into punching position information, which is sent to a data processing device; disposing a plurality of student punching bags; and connecting the plurality of student punching bags to the data processing device, receiving the punching position information synchronously, and converting the punching position information into a light control signal, so as to control the plurality of display lights synchronously to allow a plurality of students to punch the corresponding punching practice zones according to positions of the display lights.

### CROSS-REFFERENCE TO RELATED APPLICATION

This application claims priority from Taiwan Patent Application No. 109126459, filed on Aug. 5, 2020, in the Taiwan Intellectual Property Office, the content of which is hereby incorporated by reference in its entirety for all purposes.

### BACKGROUND

### 1. Technical Field

The present disclosure relates to a synchronous control method for boxing punching bag, particularly to a control method of using a sensing signal representing coach punching positions, converting the sensing signal to a control signal and providing display lights of student punching positions by the control signal, thereby achieving the synchronization of the coach punching bag and the student punching bags.

### 2. Description of the Related Art

Aerobic boxing is one of the most popular sports among the existing sports fitness activities. Aerobic boxing combines boxing and aerobic exercises. Through the movement of boxing, the effect of calorie consumption, body coordination improvement, concentration enhancement, and stress releasing may be achieved. However, the general public is not familiar with boxing movements such as punching or kicking. Videos from an experienced person are often needed to guide learners to do related movements, or students have to follow the instructions from a coach on the spot to complete the movements and achieve the effect of sports fitness.

Due to the limitation on time and places, if a user wishes to do self-training at home, or it is difficult to reach a gym where a coach is for on-site learning, the relevant assisted tools are often required to achieve the training effect. In terms of the aforementioned boxing movements, a punching bag may be used as a training aid for punching and kicking on specific positions. Through punching a particular position on the punching bag, related boxing movements can be completed. However, to punch a particular position on the punching bag or punch the bag in a predetermined order, guidance from a coach is still necessary. Even though the coach can record related videos as teaching materials, the user will be able to get stared more easily to complete performing related movements.

In this view, how to establish a technique for synchronously controlling boxing punching bags to overcome the limitation on time and places will be the goal that the related sports fitness industries hope to achieve. Accordingly, the inventor of the present disclosure has designed a synchronous control method for boxing punching bag in an effort to tackle deficiencies in the prior art and further to enhance the implementation and application in industries.

### SUMMARY

In view of the aforementioned conventional problem, the objectives of the present disclosure are to provide a synchronous control boxing punching bag to solve the problem of difficulty in assisting the user in training with the punching bag.

According to one objective of the present disclosure, a synchronous control method for boxing punching bag is provided, including: disposing a coach punching bag, wherein the coach punching bag includes a plurality of punching zones and a plurality of IoT sensors corresponding to the plurality of punching zones; sensing a boxing movement from a coach by the plurality of IoT sensors and converting punching positions of the boxing movement into punching position information, which is sent to a data processing device; disposing a plurality of student punching bags, wherein the plurality of student punching bags respectively includes a plurality of punching practice zones corresponding to the plurality of punching zones, and the plurality of punching practice zones respectively includes a plurality of display lights; and connecting the plurality of student punching bags to the data processing device, receiving the punching position information synchronously, and converting the punching position information into a light control signal, so as to control the plurality of display lights synchronously to allow a plurality of students to punch the corresponding punching practice zones according to positions of the display lights.

Preferably, the synchronous control method may further include: disposing a pressure sensor corresponding to the plurality of punching practice zones and storing training information from the plurality of students in a storage device.

Preferably, each of the plurality of student punching bags may include an output device, and the output device outputs interactive information to another student punching bag or returns the interactive information to the coach punching bag.

Preferably, the data processing device may include a handheld device and a server, the IoT sensor sends the punching position information to the handheld device via Bluetooth transmission, and the handheld device sends the punching position information to the server via a wireless communication network.

Preferably, the plurality of student punching bags may be connected to the server via a student handheld device and receive the punching position information via the wireless communication network, respectively.

Preferably, the data processing device may include a wireless base station, and the IoT sensor sends the punching position information to the wireless base station via a wireless local area network.

Preferably, the plurality of student punching bags may be connected to the wireless base station via the wireless local area network and receive the punching position information via the wireless local area network.

Preferably, the data processing device may record a continuous movement of the coach and convert the continuous movement into punching position information and punching order information, and the plurality of student punching bags controls the plurality of display lights to light up in order according to the punching order information.

Preferably, the IoT sensor may sense the force of the boxing movement and convert the force into force information, the force information is subsequently sent to the data processing device.

Preferably, the plurality of display lights may include a plurality of display colors, and the plurality of student punching bags controls the plurality of display lights to show different display colors according to the force information.

As mentioned above, the synchronous control method for boxing punching bag of the present disclosure may have one or more following advantages:

(1) The synchronous control method for boxing punching bag allows students to follow the boxing movements from the coach synchronously, effectively achieving the effect of sports fitness.

(2) The synchronous control method for boxing punching bag allows students to intuitively punch correct zones by following the indication of display lights, thus improving the accuracy of the boxing movements.

(3) The synchronous control method for boxing punching bag may achieve synchronization control through different connection methods, thus increasing the diversity of use.

### BRIEF DESCRIPTION OF THE DRAWINGS

To make the technical features, content, and advantages of the present disclosure and the achievable effects more obvious, the present disclosure is described in detail together with the drawings and in the form of expressions of the embodiments as follows:

FIG. 1 is a flowchart of synchronous control method for boxing punching bag according to an embodiment of the present disclosure.

FIG. 2 is a flowchart of the synchronous signal transmission method according to the first embodiment of the present disclosure.

FIG. 3 is a flowchart of the synchronous signal transmission method according to the second embodiment of the present disclosure.

FIG. 4 is a schematic diagram of the synchronous control method according to the first embodiment of the present disclosure.

FIG. 5 is a schematic diagram of the synchronous control method according to the second embodiment of the present disclosure.

### DESCRIPTION OF THE PREFERRED EMBODIMENTS

To illustrate the technical features, contents, advantages, and achievable effects of the present disclosure, the embodiments together with the accompanying drawings are described in detail as follows. However, the drawings are used only for the purpose of indicating and supporting the specification, which is not necessarily the real proportion and precise configuration after the implementation of the present disclosure. Therefore, the relations of the proportion and configuration of the accompanying drawings should not be interpreted to limit the actual scope of implementation of the present disclosure.

Unless otherwise defined, all terms used herein (including technical and scientific terms) have the meanings commonly understood by a person of ordinary skill in the art. It should be further understood that, unless explicitly defined herein, the terms such as those defined in commonly used dictionaries should be interpreted as having definitions consistent with their meaning in the context of the related art and the present disclosure, and should not be construed as idealized or overly formal.

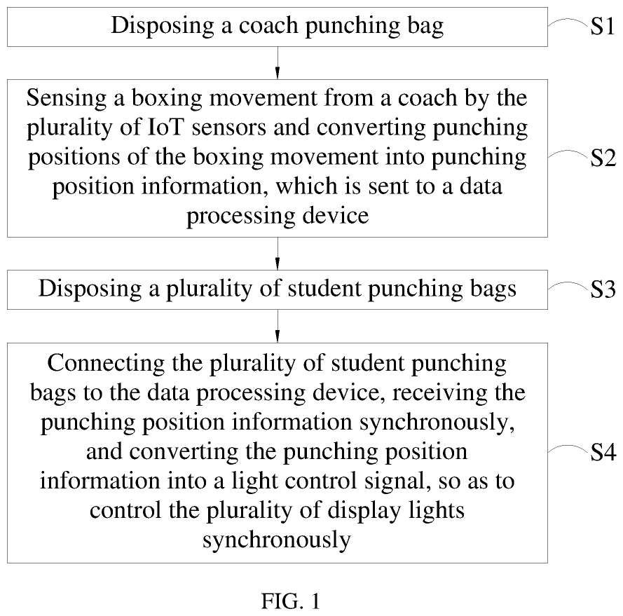

Please refer to FIG. 1, which is a flowchart of synchronous control method for boxing punching bag according to an embodiment of the present disclosure. As shown in the figure, the synchronous control method for boxing punching bag includes the following steps (S1-S4):

Step S1: disposing a coach punching bag. A coach punching bag is disposed for an instructor. The coach punching bag is a boxing punching bag in a gym or a personal place, which may be used as a training aid to instruct students to do boxing movements. The coach punching bag may be composed of soft cushions covered with materials such as leather. A plurality of punching zones may be included on the front and two sides of the cushion, for instance, three punching zones, namely upper, middle, and lower zones, are provided on the front or sides. However, the present disclosure is not limited thereto. The appearance of the punching bag and the disposition of the punching zones may be adjusted based on the type of boxing movements. For instance, the sandbag may be only disposed with a flat punching zone or subdivided into more punching zones. A corresponding IoT sensor is disposed in each of the punching zones. The types of sensors include but are not limited to pressure sensors, contact sensors, etc. When a specific punching zone is punched or kicked, the sensing elements of the sensor are squeezed and the resistance and current of the sensing elements are changed, such that the sensor generates a corresponding sensing signal, that is, the sensing signal corresponding to the punching zone.

The sensing signal generated by the sensor is sent to the signal receiver through an IoT transmission device. Each IoT sensor may include a signal transmitter and send the sensing signal to an external signal receiver through a wireless local area network, WiFi, Bluetooth communication, etc. In another embodiment, the boxing punching bag may be disposed with a processing device, including a processor, memory, network communication antenna, etc. The sensing signals of different punching zones may be stored in the processing device of the punching bag and sent to the external signal receiver by the communication device.

Step S2: sensing a boxing movement from a coach by the plurality of IoT sensors and converting punching positions of the boxing movement into punching position information, which is sent to a data processing device. After the coach punching bag is disposed, the coach may proceed to the boxing training course at the appointed time. At the start of the course, the coach punches different punching zones of the coach punching bag according to the movements. When the IoT sensor senses the movements from the coach, a sensing signal corresponding to the punching zones may be generated. The sensing signal may include punching positions, punching force, etc. The sensing signal may be subsequently sent to the data processing device through wireless transmission. The course described herein is not limited to being at the same sports venue with students or utilizing remote teaching, and the data processing device used may also be different. Different embodiments are to be further described in subsequent paragraphs.

Step S3: disposing a plurality of student punching bags. In addition to the coach disposing the coach punching bag, the students who participate in the course may also dispose student punching bags which correspond to the plurality of punching zones in the student punching bags. The student punching bags are disposed with the same plurality of punching practice zones. When the coach guides the students to move, the students may punch the same position according to the instructions, further completing the same boxing movements. As mentioned above, the students and the coach may not be in the same place, so it is difficult for the students to observe the zones punched by the coach. Even in the same place, when facing the boxing punching bags, the students also have difficulty paying attention to the coach punching positions. Therefore, the display lights corresponding to the zones are disposed in each of the punching practice zones. Through the presentation of the display lights, the punching zones are clearly indicated, such that the students may concentrate on completing the boxing movements when practicing.

Step S4: connecting the plurality of student punching bags to the data processing device, receiving the punching position information synchronously, and converting the punching position information into a light control signal, so as to control the plurality of display lights synchronously. As for the method for controlling the display lights, each of the student punching bags is connected to the data processing device, such that the student punching bags may synchronously receive the information of the coach punching positions. In addition, the information is converted into a control signal corresponding to the punching positions to control the display lights in the punching zones, such that students are instructed to punch the corresponding punching practice zones when the display lights are on. A plurality of students synchronously may therefore punch the corresponding plurality of punching practice zones according to positions of the display lights. When the coach punches the coach punching bag continuously, the display lights on the student punching bags may light up according to the information of the punching positions and the order of punching of the coach, such that the students may punch the corresponding punching practice zones in order, so as to simulate the boxing movement by the coach.

According to the aforementioned steps, no matter where the students are, at home or in a gym, the display lights on the student punching bags may synchronously light up in the same punching zones when the coach punches the coach punching bag, such that the students may intuitively punch the same positions to achieve the effect of synchronized teaching. The student punching bags may be further disposed with a pressure sensor and a storage device. When the students punch each of the punching practice zones according to the display lights, the pressure sensor senses the student punching information and records and stores the punching position, punching force, etc., in the memory. These training records allow the students to record and view the synchronous learning process through a wired or a wireless output device, such as a USB interface or Bluetooth communication interface. In other embodiments, these training records may also be sent back to the coach punching bag, and the training results may be displayed by the display lights on the coach punching bag, such that the coach may give further guidance based on the student punching results. In another embodiment, the students may also send training records or punching practice records to another student punching bags through the output device, such that students may learn from each other, or interaction among students through methods such as gaming may increase the diversity of boxing training. On the other hand, the aforementioned display lights may include different display colors. When the coach punches the punching bag, the IoT sensor may sense the force of the punches; different control signals may be sent such that the display lights may display different colors according to the force. For instance, a heavy punch is identified when displayed in red; a normal punch is identified when displayed in blue. By displaying different colors of display lights, the effect of indicating and simulating boxing movements is increased.

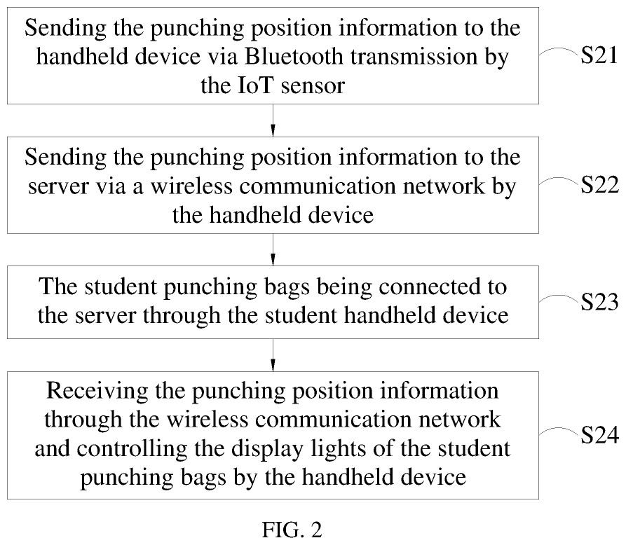

Please refer to FIG. 2, which is a flowchart of the synchronous signal transmission method according to the first embodiment of the present disclosure. As shown in the figure, the synchronous signal transmission method includes the following steps (S21-S24):

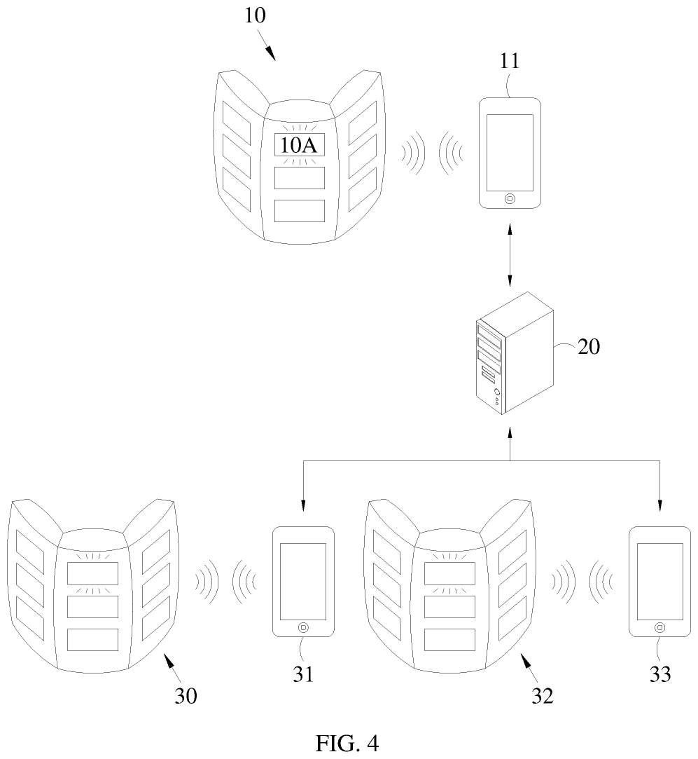

Step S21: Sending the punching position information to the handheld device via Bluetooth transmission by the IoT sensor. In the present embodiment, the coach and the students may be located in different places. For instance, the coach and the students respectively dispose boxing punching bags at home and the coach delivers a course through a remote connection. Please refer to FIG. 4 at the same time, which is a schematic diagram of the synchronous control method according to the first embodiment of the present disclosure. Firstly, the coach disposes the coach punching bag 10, including a plurality of punching zones in the center and on both sides 10A. An IoT sensor is disposed in each of the zones, and the punching zones 10A are punched by the coach to generate a sensing signal, the coach punching bag 10 may be connected to the handheld device 11 via Bluetooth transmission and send the punching position information to the handheld device 11. The handheld device 11 may be a device with wireless transmission functions, such as a smartphone, a tablet computer, a notebook computer, etc.

Step S22: Sending the punching position information to the server via a wireless communication network by the handheld device. Upon receiving the punching position information, the handheld device 11 may send the punching message to the server 20 via the wireless communication network, such as WiFi, 4G, 5G, and other wireless network transmission protocols. The server 20 may be a server computer, a cloud computer, etc., in which a data receiving platform and a database are disposed to receive the punching position information.

Step S23: The student punching bags being connected to the server through the student handheld device. The first student and the second student in different places may respectively dispose the first student punching bag 30 and the second student punching bag 32, which are respectively connected to each of the student punching bags through the Bluetooth transmission device of the first student handheld device 31 and the second student handheld device 33 and connected to the server 20 via the first student handheld device 31 and the second student handheld device 33.

Step S24: Receiving the punching position information through the wireless communication network and controlling the display lights on the student punching bags by the handheld device. Similar to the handheld device 11 of the coach, the first student handheld device 31 and the second student handheld device 33 may be connected to the data receiving platform disposed in the server 20 through the wireless communication network to access the punching position information and send the punching position information to the first student punching bag 30 and the second student punching bag 32 through Bluetooth transmission to control the display lights on the punching bags to light up synchronously, such that the students at different places may learn boxing movements according to the display lights synchronously.

After the students punch the punching bags according to the display lights, the punching information of each of the students may be sent back to the coach. For instance, the first student handheld device 31 records the training information on the first student punching bag 30 which is sent back to the handheld device 11 of the coach via the wireless communication network by the server 20. The coach may have the training result of the first student displayed by the handheld device 11 or have the training result of the first student displayed by the display lights of the coach punching bag 10. The training information of the rest of the students may also be sent back according to this method to allow the coach to obtain the result of the actual training of the students, thus achieving the effect of interactive teaching between the coach and the students. In addition, the first student punching bag 30 and the second student punching bag 32 may also send interactive information to each other. For instance, the first student sets a question by punching the punching bag, and the second student punches the punching bag along with the display lights. Through the way of learning from each other or competition, students may also interact with each other, which further increases the effect of boxing training.

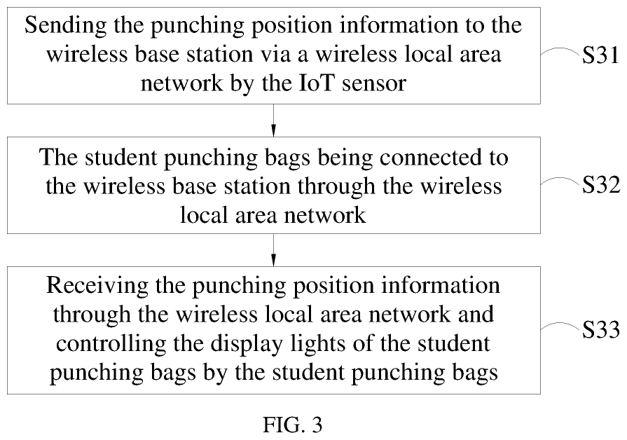

Please refer to FIG. 3, which is a flowchart of the synchronous signal transmission method according to the second embodiment of the present disclosure. As shown in the figure, the synchronous signal transmission method includes the following steps (S31-S33):

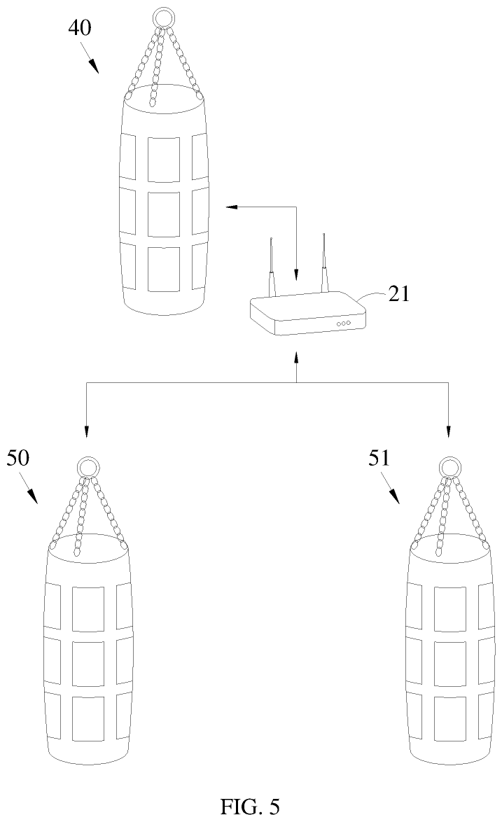

Step S31: Sending the punching position information to the wireless base station via a wireless local area network by the IoT sensor. In the present embodiment, the coach and the students may be in the same place. For instance, a plurality of punching bags are disposed in the same gym. The punching bags are connected to the wireless base station via the wireless local area network. Through setting, the punching bags in a specific network location may be designated as coach punching bags and the rest as student punching bags. Although the coach and the students are in the same space, students may not be able to observe the movements of the coach. Therefore, the synchronous control method of the present disclosure may still allow boxing teaching to be more efficient. Please refer to FIG. 5 at the same time, which is a schematic diagram of the synchronous control method according to the second embodiment of the present disclosure. The coach punching bag 40 may be a cylindrical boxing punching bag, including a plurality of punching zones in the front. An IoT sensor is disposed in each of the zones, and when the punching zones are punched by the coach to generate a sensing signal, the coach punching bag 40 may be connected to the wireless base station 21 via the wireless local area network. In the present embodiment, the wireless base station 21 may send the punching position information to the data receiving platform, and the data receiving platform may be disposed in a remote network server or a local computing device.

Step S32: The student punching bags being connected to the wireless base station through the wireless local area network. Similar to the aforementioned embodiment, the first student may use the first student punching bag 50 and the second student may use the second student punching bag 51, two of which are connected to the wireless base station 21 via the wireless local area network.

Step S33: Receiving the punching position information through the wireless local area network and controlling the display lights on the student punching bags by the student punching bags. The first student punching bag 50 and the second student punching bag 51 may be connected to the wireless base station 21 through the wireless local area network to access the punching position information of the data receiving platform, such that the punching position information of the coach may be displayed synchronously on the same position of each sandbag, further allowing each of the students to follow and complete the boxing movements as well as achieving the effect of training.

Similar to the aforementioned embodiment, the first student punching bag 50 and the second student punching bag 51 may be disposed with a pressure sensor to sense the actual punching state of the students. After recording the training information, the training information is sent back to the coach through the wireless base station 21. The coach may respectively review the training information of each of the students to provide the students with suggestions for improvement, thus enhancing the effect of training. The first student punching bag 50 and the second student punching bag 51 may also send interactive information to each other, such that each of the students may also interact with each other through the boxing punching bags.

The above description is merely illustrative rather than restrictive. Any equivalent modifications or alterations without departing from the spirit and scope of the present disclosure are intended to be included in the following claims.

What is claimed is:

1. A synchronous control method for boxing punching bag, comprising:
disposing a coach punching bag, the coach punching bag comprising a plurality of punching zones and a plurality of IoT sensors corresponding to the plurality of punching zones;
sensing a boxing movement from a coach by the plurality of IoT sensors and converting punching positions of the boxing movement into punching position information, the punching position information subsequently being sent to a data processing device;
disposing a plurality of student punching bags, the plurality of student punching bags respectively comprising a plurality of punching practice zones corresponding to the plurality of punching zones, and the plurality of punching practice zones respectively comprising a plurality of display lights; and
connecting the plurality of student punching bags to the data processing device, receiving the punching position information synchronously, and converting the punching position information into a light control signal, so as to control the plurality of display lights synchronously to allow a plurality of students to punch the corresponding punching practice zones according to positions of the display lights.

2. The synchronous control method according to claim 1, further comprising:
disposing a pressure sensor corresponding to the plurality of punching practice zones and storing training information from the plurality of students in a storage device.

3. The synchronous control method according to claim 1, wherein each of the plurality of student punching bags comprises an output device and the output device outputs interactive information to another student punching bag or returns the interactive information to the coach punching bag.

4. The synchronous control method according to claim 1, wherein the data processing device comprises a handheld device and a server, the IoT sensor sends the punching position information to the handheld device via Bluetooth transmission, and the handheld device sends the punching position information to the server via a wireless communication network.

5. The synchronous control method according to claim 4, wherein the plurality of student punching bags are connected to the server via a student handheld device and receive the punching position information via the wireless communication network, respectively.

6. The synchronous control method according to claim 1, wherein the data processing device comprises a wireless base station, and the IoT sensor sends the punching position information to the wireless base station via a wireless local area network.

7. The synchronous control method according to claim 6, wherein the plurality of student punching bags are connected to the wireless base station via the wireless local area network and receive the punching position information via the wireless local area network.

8. The synchronous control method according to claim 1, wherein the data processing device records a continuous movement of the coach and converts the continuous movement into punching position information and punching order information, and the plurality of student punching bags control the plurality of display lights to light up according to the punching order information.

9. The synchronous control method according to claim 1, wherein the IoT sensor senses force of the boxing movement and converts the force into force information, the for information is subsequently sent to the data processing device.

10. The synchronous control method according to claim 9, wherein the plurality of display lights comprise a plurality of display colors, and the plurality of student punching bags control the plurality of display lights to show different display colors according to the force information.
